(19) United States
(12) Patent Application Publication
(10) Pub. No.: US 2008/0111358 A1
(43) Pub. Date: May 15, 2008

(54) Airbag inflator integral pressure relief component

(75) Inventors: Scott Jackson, Centerville, UT (US); Bryce Robinette, Brigham City, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/599,149

(22) Filed: Nov. 14, 2006

(51) Int. Cl. B60R 21/268

(52) U.S. Cl. 280/741

(57) ABSTRACT

An inflator is disclosed herein. The inflator includes an initiator and a chamber that houses a quantity of stored gas. The initiator may be capable of actuating and causing the stored gas within the chamber to exit the chamber. A venting dome is also added to the initiator. The venting dome opens during deployment of the inflator. The venting dome also inverts and opens an aperture through which the stored gas may vent out of the inflator if the pressure of the stored gas exceeds a threshold level.

### BACKGROUND OF THE INVENTION

Airbags and airbag systems are known in the art and are now standard on motor vehicles. These airbag systems generally are designed such that in the event of an accident or a crash, an inflatable airbag will become positioned in front of a vehicle occupant and will prevent the vehicle occupant from harmful impact with a portion of the vehicle interior. As is known in the art, airbags are currently added to the vehicle's steering wheel, dashboard, and/or at other locations on the vehicle. The inclusion of these airbag systems onto motor vehicles have been credited with saving many lives and preventing many injuries.

In order to rapidly inflate an airbag during a crash, an airbag inflator is included as part of the airbag system. The airbag inflator is a device that, upon activation, will rapidly produce and/or channel a large quantity of inflation gas into the airbag. Such an influx of inflation gas causes the airbag to inflate and deploy into the vehicle interior.

One type of inflator known in the art is a “stored gas” inflator. These stored gas inflators may be used on a variety of airbag applications, including “side-impact” or “inflatable curtain” airbags. A stored gas inflator includes a quantity of stored, pressurized gas that is housed within a sealed chamber. In the event of an accident or crash, this chamber will unseal. Such unsealing of the chamber allows the pressurized gas to rapidly exit the inflator. Of course, once the gas exits the inflator, this gas may be channeled into the airbag.

Because the stored gas is housed under significant pressure, care must be taken to ensure that the stored gas inflator does not prematurely become propulsive (and/or explode). For example, if the structural integrity of the inflator somehow fails, the pressurized gas stored within the chamber will rapidly exit the inflator, thereby converting the inflator into a dangerous projectile. In the industry, the conversion of the inflator into a projectile is often referred as the inflator becoming “propulsive.” The danger associated with the inflator becoming propulsive is often magnified if the temperature of the stored gas is significantly increased (such as during a fire that may occur while the inflator is being shipped or stored in a warehouse). Also, there is a possibility that the inflator will become propulsive if the vehicle onto which the inflator has been installed catches fire.

In order to mitigate the dangers of inflators becoming propulsive, inflators are generally required to have a method to vent the stored, pressurized gas, in the event that the inflator is involved in a fire. The gas is required to vent at a temperature at which the structural integrity of the pressure vessel is not compromised, thereby ensuring safe venting.

Current practice for stored gas inflators is to design the strength of the metal burst disks as the pressure-release mechanism. These disks are designed such that, as the temperature increases, the internal pressure of the inflator eventually overcomes the strength of the disks and allows the gas to vent out of the inflator.

Generally, the use of metal burst disks also requires some feature to be designed into the inflator (or a component added to the inflator) to diffuse the exiting gas in a manner that prevents the inflator from becoming propulsive. Adding such diffusing features or components to the inflator increases the number of parts required to produce the inflator and/or it requires additional processes during the manufacturing processes. Accordingly, the inclusion of these mandatory gas diffusing components significantly increases the costs associated with producing the stored gas inflator.

Therefore, there is a need in the art to provide a new type of stored gas inflator that is relatively inexpensive to manufacture, yet will adequately vent the stored gas and prevent the inflator from becoming propulsive. Such a device is disclosed herein.

### BRIEF SUMMARY OF THE INVENTION

An inflator is disclosed herein. The inflator includes an initiator and a chamber that houses a quantity of stored gas. The initiator may be capable of actuating and causing the stored gas within the chamber to exit the chamber. A venting dome is also added to the initiator. The venting dome opens during deployment of the inflator. The venting dome also inverts and opens an aperture through which the stored gas may vent out of the inflator if the pressure of the stored gas exceeds a threshold level.

In some embodiments, the venting dome will be scored. This scoring may, in some embodiments, be in a cross-pattern. In other embodiments, the scoring of the venting dome comprises a point. Further embodiments are designed in which the venting dome comprises a thinned area at the apex of dome.

The venting dome may be associated with the initiator. In these embodiments, actuation of the initiator opens the venting dome towards the chamber. Yet further embodiments may be designed in which the venting dome extends inwardly into the chamber.

The pressure of the stored gas housed within the chamber will increase if the inflator is heated. If such heating of the inflator occurs, the increased gas pressure causes the dome to invert and an aperture will form in the dome. In some embodiments, once the dome has inverted and the aperture has opened, the stored gas vents out of the inflator proximate the initiator.

The present embodiments also relate to a method for diffusing increased pressure of a stored gas inflator due to increased heat. One step in the method involves obtaining an inflator. This inflator comprises an initiator, a chamber housing a quantity of stored gas, and a venting dome. In some embodiments, the venting dome extends inwardly into the chamber. The venting dome is designed to open during deployment of the inflator. The method also includes the step of configuring the venting dome to invert and open an aperture through which the stored gas may vent out of the inflator if the pressure of the stored gas exceeds a threshold level. In some embodiments, the stored gas will be vented out of the inflator (after the aperture has opened) through a flow path that is proximate to the initiator.

It should be noted that the present inflators are designed to address one or more of the needs known in the art. These inflators are generally a stored gas inflator which means that the inflator includes a quantity of stored gas that is housed within a chamber. An initiator is also added to the inflator. The initiator may be used to actuate the inflator.

A venting dome is also included as part of the inflator. The venting dome may be associated with the initiator. In fact, in some embodiments, the venting dome will surround all or a part of the initiator.

In the event of an accident or crash, the initiator will be actuated. Such actuation of the initiator opens a hole or opening in the venting dome. Once an opening in the venting dome has been created, any gas created during actuation of the initiator may enter the chamber and mix with the stored gas. Once this gas enters the chamber, the chamber housing the gas will unseal and the stored gas will exit the chamber (so that it may be channeled into an airbag).

The venting dome may also be designed such that it will prevent the inflator from becoming propulsive (such as during a fire or in other situations in which heat is transmitted to the inflator). When heat is imparted to the inflator, the pressure of the stored gas within the chamber will increase. At some point, this increase in pressure will cause the pressure of the gas to exceed a specified, set threshold value. Once this threshold value is exceeded, the pressurized gas will push against the venting dome to (or at least a portion of the venting dome), thereby causing the dome to invert. In some embodiments, the apex of the venting dome will be the portion of the venting dome that is inverted.

When the venting dome inverts, the dome also opens an aperture in the dome. This aperture is an opening through which the stored gas may exit. Various sizes of the aperture are possible. Multiple apertures are also possible. When this aperture is opened, the stored gas housed in the chamber may exit the chamber by passing through the aperture. In some embodiments, the total flow area of this aperture(s) will be small enough as to control the flow rate of the escaping gas in a manner such that the resultant force imparted to the inflator is not high enough to cause the inflator to be propulsive. The area surrounding, in, and/or proximate the initiator is generally not airtight. Accordingly, once the stored gas exits the chamber by passing through the aperture, the gas may vent out of the inflator through one or more flow paths that are in and/or proximate the initiator. As the gas exits the inflator, the internal pressure of the stored gas is diffused and the inflator is prevented from becoming propulsive.

In further embodiments, one or more score marks may also be added to the dome to assist in the creation of the aperture upon inversion of the dome. These score marks may be made in a cross pattern, may be a single point or may be other suitable scoring. Other embodiments may be constructed in which the venting dome comprises a thinned area at or near the apex of the dome.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a cross-sectional view of an inflator according to the present embodiments prior to deployment;

FIG. 1a is an expanded view of a portion of FIG. 1 that is provided for clarity;

FIG. 2 is a cross-sectional view of an inflator of FIG. 1 shown after deployment;

FIG. 3 is a cross-sectional view of an inflator of FIG. 1 which shows the way in which the pressurized gas may be diffused out of the inflator;

FIG. 3 is an expanded view of a portion of FIG. 3 that is provided for clarity

FIG. 4 is a perspective view of another embodiment of a venting dome that may be used in conjunction with inflators of the present embodiments;

FIG. 5 is a perspective view of another embodiment of a venting dome that may be used in conjunction with inflators of the present embodiments; and

FIG. 6 is a cross-sectional view that is similar to FIG. 1a that illustrates another embodiment of a venting dome with a thinned area at its apex that may be used in conjunction with inflators of the present embodiments.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

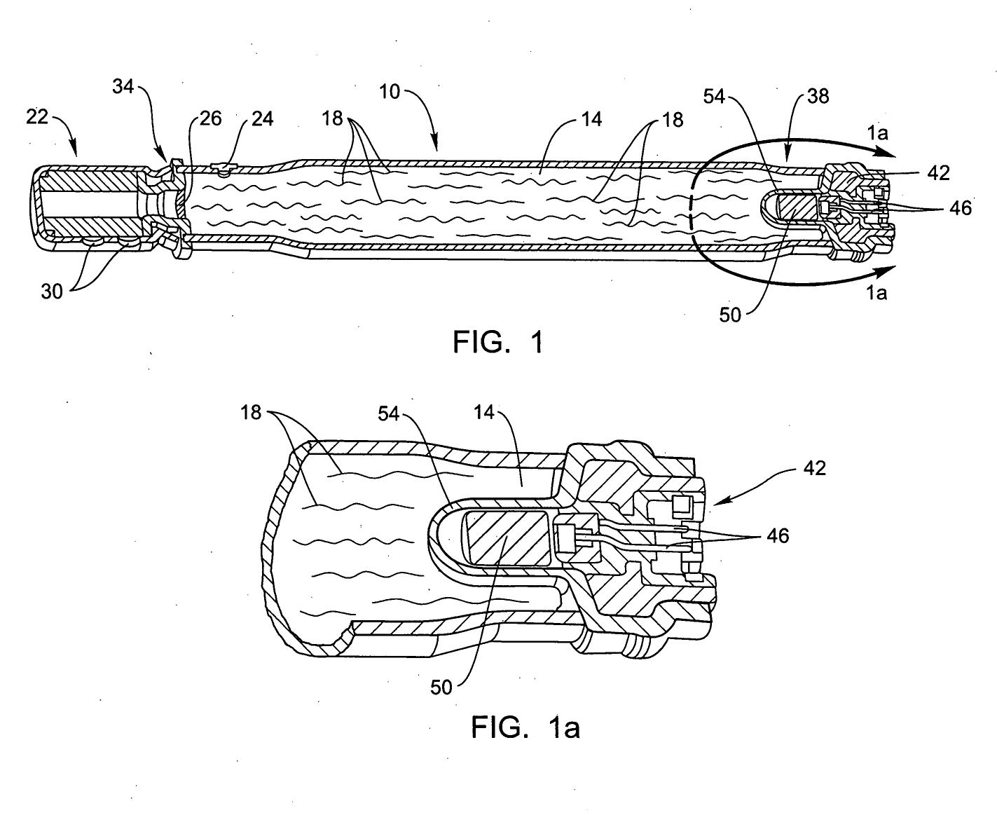

Referring now to FIG. 1, a cross-sectional view illustrates an inflator 10 according to the present embodiments. As is known in the art, the inflator 10 is designed such that it may be used to inflate an airbag (not shown) in the event of an accident or crash. The inflator 10 includes a chamber 14 that houses a quantity of stored gas 18. More specifically, in the event of an accident or crash, the inflator 10 will actuate and will allow the quantity of stored gas 18 to be channeled into the airbag. Such an influx of the gas 18 into the airbag causes the airbag to deploy.

It should be noted that in the embodiment of FIG. 1, only stored gas 18 is found within the chamber 14. However, other embodiments may be constructed in which a quantity of gas generant (pyrotechnic material) is also added to the chamber 14. In these embodiments, the deployment of the inflator 10 will also cause the gas generant to react and create an additional quantity of gas that may be used to inflate the airbag.

As shown in FIG. 1, the inflator 10 may include a diffuser 22 and a burst disk 26. The burst disk 26 seals the chamber 14. One or more seals 24 may also be added to hold the gas 18 within the chamber 14 prior to deployment of the inflator 10. As shown in FIG. 1, the seal 24 is positioned proximate a first end 34 of the inflator 10. Other embodiments may be designed in which the seal 24 is positioned at a second end 38 of the inflator 10, or at any position along the longitudinal length of the inflator 10, as desired.

The burst disk 26 is designed such that when the inflator 10 is actuated, the burst disk 26 will rupture. Once ruptured, the stored gas 18 will then flow out of the chamber 14 into the diffuser 22. After exiting the chamber 14, the stored gas 18 may then pass through the diffuser 22 and exit the inflator 10 via one or more exit ports 30.

As shown in FIG. 1, the inflator 10 is cylindrical in shape and the diffuser 22 and the exit ports 30 are positioned proximate a first end 34 of the inflator 10. Of course, in other embodiments, the exit ports 30 and/or the diffuser 22 may be positioned at a second end 38 of the inflator 10. Further embodiments may have the exit ports 30 and/or the diffuser 22 positioned along a middle (or middle portion of the inflator 10). Also, other shapes for the inflator 10 (other than cylindrical) are also possible.

The burst disk 26, as shown in FIG. 1, is positioned proximate an end of the chamber 14. In other embodiments, different locations for the burst disk 26 may also be used. Likewise, as is known in the art, one or more filters, screens, or other similar features may also be added to the inflator 10 to filter the stored gas 18 prior to having the stored gas 18 exit the inflator 10.

The inflator 10 also includes an initiator 42 that may be used to actuate the inflator 10. The initiator 42, as shown in FIG. 1, is positioned at the second end 38 of the inflator 10. However, other positions for the initiator 42 are also possible. For clarity, the initiator 42 and other portions of the inflator 10 have been expanded in FIG. 1a.

In the embodiment shown in FIG. 1, the initiator 42 also includes one or more wires 46 and a pyrotechnic material 50. As described herein, the initiator 42 may be actuated. This actuation of the initiator 42 will result in deployment of the inflator 10.

A venting dome 54 is also included as part of the inflator 10. The venting dome 54 may be positioned proximate the second end 38 and extend inwardly into the chamber 14. The venting dome 54 may be associated with the initiator 42. In fact, in the embodiment shown in FIG. 1, the venting dome 54 surrounds all or a portion of the initiator 42. In further embodiments, the venting dome 54 will surround all or a portion of the pyrotechnic material 50.

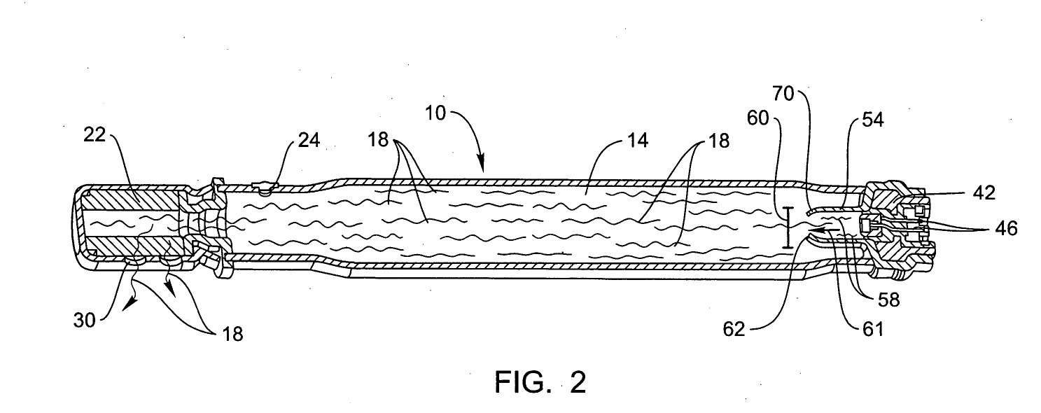

Referring now to FIG. 2, the deployment of the inflator 10 will now be described. In the event that a crash is sensed, a signal will be sent to the inflator 10. The signal will activate the initiator 42. Such activation of the initiator 42 will cause current or an electrical charge to pass through the wires 46. In turn, this electrical charge or current will ignite the pyrotechnic material 50 (shown in FIG. 1). As shown in FIG. 2, this ignition of the pyrotechnic material 50 creates a quantity of gas 58.

Actuation of the initiator 42 also opens the venting dome 54. This may occur by having the ignition of the pyrotechnic material 50 burn/create an opening 62 in the venting dome 54. Once an opening in the venting dome 54 has been created, the gas 58 may enter the chamber 14 and mix with the stored gas 18 (and ultimately be used to inflate the airbag). This flow of the gas 58 out of the initiator 42 is illustrated by arrow 61.

In the embodiment shown in FIG. 2, the opening 62 formed is roughly equal to the diameter 60 of the dome. Further embodiments may be constructed in which the size of the opening 62 is less than or equal to the dome diameter 60. In other embodiments, the opening 62 may be formed as the dome 54 is shredded/punctured as part of the actuation process. In yet further embodiments, multiple openings 62 may be formed in the venting dome 54 in a variety of different configurations or arrangements. In the embodiment shown in FIG. 2, the opening 62 is located at the apex 70 of the dome.

In some embodiments, the actuation of the initiator 42 will cause the burst disk 26 to rupture. Once this burst disk 26 has ruptured, the gas 18 may then exit the inflator 10 in the manner described above. In other embodiments, the actuation of the initiator 42 may unseal the seal 24 and allow the gas 18 to escape the chamber 14 via the opening created in the seal 24. In further embodiments, the area of the inflator 10 that is proximate to the initiator 42 will not be airtight, and thus, the stored gas 18 may exit the chamber 14 by passing through the opening 62 and the flow path(s) created by the non-airtight placement of the initiator 42.

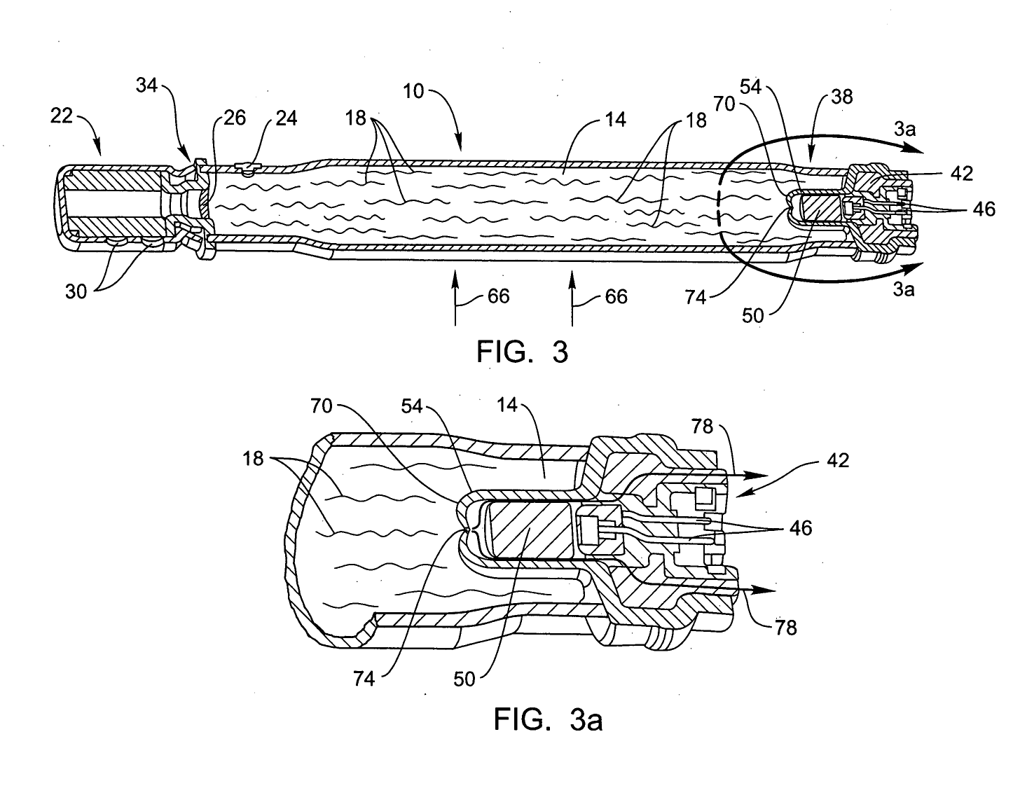

Referring now to FIG. 3, a cross-sectional embodiment illustrates further aspects of the inflator 10. Specifically, FIG. 3 is a cross-sectional view that is similar to the view shown in FIG. 1. FIG. 3 illustrates the inflator 10 when heat 66 (represented graphically by arrows) is added to the inflator 10. This heat 66 may be added if the inflator 10 is involved in a fire. As mentioned above, this fire may occur while the inflator 10 is being shipped or being housed in a warehouse (or other similar storage facility). Another example of when a fire could impart heat to the inflator 10 occurs when the vehicle, to which the inflator 10 is attached, catches fire.

The venting dome 54 is designed to allow the inflator 10 to vent out the stored gas 18 in the event that a fire occurs. Thus, the presence of the venting dome 54 means that, when heat 66 is imparted to the inflator 10, the inflator 10 will not become propulsive. Again, for purposes of clarity, portions of the inflator 10, including initiator 42 and the venting dome 54 have been expanded as part of FIG. 3a.

When heat 66 is imparted to the inflator 10, the pressure of the stored gas 18 within the chamber 14 will increase (in accordance with the fundamental chemical equation PV=nRT). If a sufficient amount of heat 66 is added, the pressure of the stored gas 18 will exceed a particular threshold value, the pressure of the stored gas 18 causes the venting dome 54 to invert, as shown in FIG. 3. In other words, when the pressure of the gas 18 exceeds a threshold value, the pressurized gas 18 will push against the venting dome 54 and invert the apex 70 of the venting dome 54.

As noted above, the venting dome 54 will invert after the internal pressure exceeds a certain threshold level. The exact value of the “threshold level” necessary for inverting the venting dome 54 will depend on a variety of factors, such as the size of the inflator 10, the amount of the stored gas 18, the material used to make the inflator 10, the material used to construct the venting dome 54, etc. In general, the value of this threshold level will be set to prevent the inflator 10 from becoming propulsive. In other words, as the pressure of the stored gas 18 increases, the pressure will exceed the threshold level (and thus invert the dome 54) before the inflator 10 has an opportunity to become propulsive.

When the venting dome 54 inverts, the dome 54 also opens an aperture 74 in the dome 54. This aperture 74 is a small opening through which the stored gas 18 may exit. In other embodiments, more than one aperture 74 may be opened. This means that when the aperture 74 opens, the stored gas 18 housed in the chamber 14 may exit the chamber 14 by passing through the aperture 74. In general, the area surrounding the initiator 42 will not be airtight. Accordingly, once the stored gas 18 passes through the aperture 74, the gas 18 may vent out of the inflator 10 through one or more flow paths that are in and/or proximate the initiator 42. One example of a flow path that is through and/or proximate the initiator 42 is shown with arrow 78 (on FIG. 3a). Other flow paths and/or areas through which the gas may flow that are through and/or proximate the initiator 42 are also possible. Thus, once the aperture 74 has formed, gas 18 may vent out of the inflator 10 at a slow rate, thereby diffusing the internal pressure of the stored gas 18 and preventing the inflator 10 from becoming propulsive.

As disclosed herein, the venting dome 54 is capable of opening during deployment of the inflator 10, and is also capable of inverting and opening and aperture 74 that allows the stored gas 18 to diffuse out of the inflator 10 and relieve the internal pressure. Those of skill in the art will recognize how to construct the venting dome 54 so that it is capable of performing these functionalities. For example, the size and/or formation of the aperture 74 can be controlled through the proper design of the dome 54 to allow a very slow venting of the gas 18, which reduces significantly the force of the exiting gas and virtually eliminates any propulsive force created. Key parameters to consider in the design of the dome may include the material properties, the shape, the material thickness, and the geometry of any features in the dome to cause a controlled weak spot. Such geometry may be a pattern of lines or grooves to create stress concentration at a particular point during pressurized loading of the dome. Some designs may have a controlled weak spot that when over-pressurized would buckle and crack opening up a small aperture to release pressurized gas at a controlled rate. Some testing may be necessary to determine the appropriate and/or optimal strength and geometry of the dome for a particular application. This geometry may also be combined with other functions to reduce the overall number of components and cost of the inflator.

In further embodiments, one or more score marks may also be added to the dome 54 to assist in the creation of the aperture 74 upon inversion of the dome 54.

It should be noted that the inclusion of the venting dome 54 may, in some embodiments, provide advantages over other inflators. For example, the inclusion of the dome 54 allows for an efficient diffusion of the gas 18 at high temperatures, thereby obviating the need for an expensive burst disk or other similar diffusing component features. Accordingly, the inflators that incorporate this venting dome 54 may be less expensive and easier to manufacture.

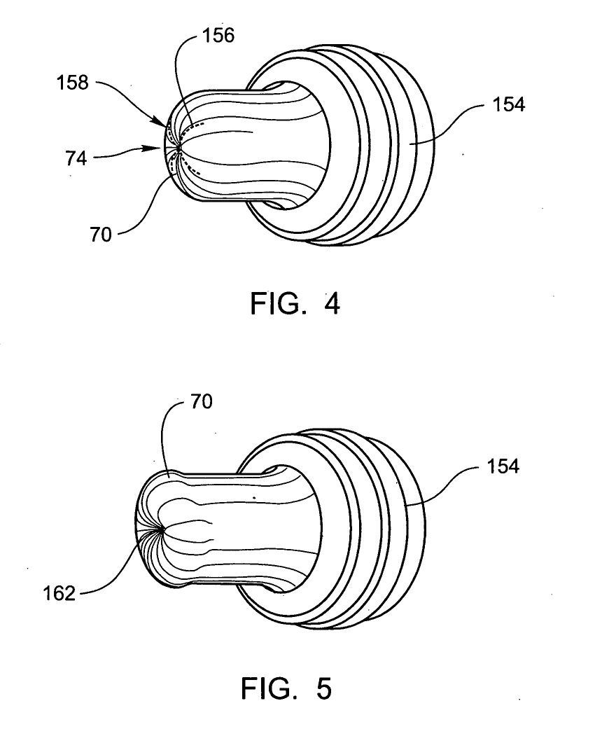

Referring now to FIG. 4, a second embodiment of a venting dome 154 according to the present embodiments is illustrated. The venting dome 154 is similar to the venting dome 54 discussed above and may be incorporated into the inflator 10. The venting dome 154 differs from the dome 54 in that the venting dome 154 is scored with one or more score lines 156. These score lines 156 may be cut, pressed, or otherwise added to the venting dome 154. In some embodiments, the score lines 156 may be a weakened area of the dome 154. In other embodiments, the score lines 156 are positioned at the dome's apex 70. The score lines 156 may be designed to allow the venting dome 154 to open along the score lines 156 during deployment of the inflator. Further embodiments may also be constructed in which the score lines 156 facilitate the opening of the aperture 74, in the event that the dome 154 inverts as a result of an increase in the pressure of the stored gas above a set threshold level.

As shown in FIG. 4, the score lines 156 are positioned in a “cross” pattern 158. However, in the embodiment shown in FIG. 5, the scoring in the venting dome 154 is a point 162 (or a plurality of points). This point may be positioned at the apex 70 of the dome 154. Other configurations and/or shapes for the scoring may also be implemented.

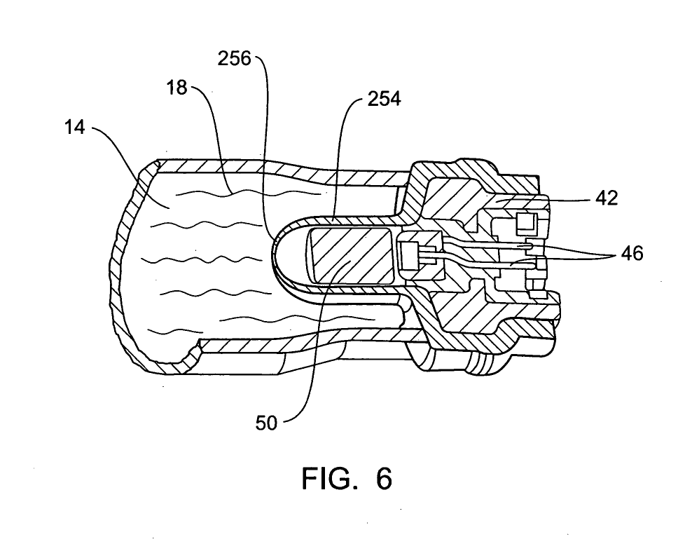

Referring now to FIG. 6, another embodiment of a venting dome 254 is also illustrated. This venting dome 254 is similar to the venting domes previously described and may be used as part of the inflator 10. In this embodiment, the apex 70 of the dome 254 comprises a thinned area 256. The inclusion of this thinned area 256 may, in some embodiments, facilitate the rupturing of the dome 254 during deployment. In other embodiments, the inclusion of the thinned area 256 may facilitate the inversion of the dome 254 and the opening of an aperture, in the event that the internal pressure of the stored gas exceeds a set threshold level.

It should be noted that, like the venting dome 54, the venting domes 154, 254 described in FIGS. 4 through 6 may invert and open an aperture through which the stored gas may vent out of the inflator if the pressure of the stored gas exceeds a threshold level. Such venting of the gas, in these situations, allows the domes 154, 254 to diffuse the internal pressure of the inflator and prevents the inflators from becoming propulsive. Accordingly, the inclusion of these venting domes 154, 254 in the inflator may be desirable in some embodiments.

Referring now to FIGS. 1 through 6 generally, the present embodiments also include a method for diffusing increased pressure of a stored gas inflator 10 due to increased heat 66 added to the inflator 10. This method will generally involve obtaining an inflator 10. This inflator 10 comprises an initiator 42, a chamber 14 and a quantity of stored gas 18 that is housed within the chamber 14. A venting dome 54, 154, 254 is also added. The venting dome venting dome 54, 154, 254 opens during deployment of the inflator 10. The method also may involve the step of configuring the venting dome 54, 154, 254 to invert and open an aperture 74 through which the stored gas 18 may vent out of the inflator 10 if the pressure of the stored gas 18 exceeds a threshold level. In some embodiments, the stored gas 18 is vented out of the inflator 10 proximate to the initiator 42. In other embodiments, the venting dome 54, 154, 254 extends inwardly into the chamber 14.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflator comprising:
a chamber housing a quantity of stored gas;
an initiator; and
a venting dome that opens during deployment of the inflator, wherein the venting dome inverts and opens an aperture through which the stored gas may vent out of the inflator if the pressure of the stored gas exceeds a threshold level.

2. The inflator of claim 1 wherein the venting dome is associated with the initiator, and wherein upon receipt of a signal, the initiator actuates causing the stored gas to exit the chamber.

3. The inflator of claim 2 wherein upon actuation of the initiator opens the venting dome towards the chamber.

4. The inflator of claim 1 wherein the venting dome is scored.

5. The inflator of claim 4 wherein the scoring of the venting dome comprises a cross pattern.

6. The inflator of claim 4 wherein the scoring of the venting dome comprises a point.

7. The inflator of claim 1 wherein the venting dome comprises a thinned area at the apex of the dome.

8. The inflator of claim 1 wherein the pressure of the stored gas increases if the inflator is heated.

9. The inflator of claim 1 wherein if the dome has inverted and the aperture has opened, the stored gas vents out of the inflator proximate the initiator.

10. The inflator of claim 1 wherein the venting dome extends inwardly into the chamber.

11. A method for diffusing increased pressure of a stored gas inflator due to increased heat, the method comprising:
obtaining an inflator, the inflator comprising an initiator, a chamber housing a quantity of stored gas, and a venting dome, wherein the venting dome opens during deployment of the inflator;
configuring the venting dome to invert and open an aperture through which the stored gas may vent out of the inflator if the pressure of the stored gas exceeds a threshold level.

12. A method for the pressure of a stored gas inflator as in claim 11 wherein the stored gas is vented out of the inflator proximate to the initiator.

13. A method as in claim 11 wherein the venting dome extends inwardly into the chamber.
